(19) United States
(12) Patent Application Publication
(10) Pub. No.: US 2025/0072580 A1
(43) Pub. Date: Mar. 6, 2025

(54) COSMETIC PRODUCT APPLICATION DEVICE

(71) Applicant: COSMOGEN SAS, Paris (FR)

(72) Inventors: Hugues CHABRERIE, ISSY-LES-MOULINEAUX (FR); Christophe BENIGNI, PANTIN (FR)

(73) Assignee: COSMOGEN SAS, Paris (FR)

(21) Appl. No.: 18/330,861

(22) Filed: Aug. 28, 2023

(51) Int. Cl. A45D 34/04; B33Y 10/00; B33Y 80/00

(52) U.S. Cl. CPC A45D 34/04; B33Y 10/00; B33Y 80/00; A45D 2200/10; A45D 2200/25

(57) ABSTRACT

A cosmetic product application device includes an application head, the application head having a cosmetic product loading area including a cavity formed in the application head and opening outwards the application head through at least one orifice. The application head includes a material whose thermal effusivity is higher than that of a target surface, the target surface being the skin of a user. The application head also includes asperities.

### FIELD

The present disclosure concerns the field of cosmetic applicators. More particularly, the present disclosure relates to a device for applying a cosmetic product such as a cream or a cosmetic gel, over a target surface such as the skin of a user.

### BACKGROUND

By “cosmetic product”, it should be understood any substance or preparation mentioned in Article L658-1 of the Public health code, i.e. in particular a substance or a preparation intended to be brought into contact with various superficial portions of the human body in order to clean them, protect them, keep them in good condition, modify their aspect, perfume them or correct their smell.

The target surface may consist of any superficial portion of a human body such as the skin, the hair or the nails.

Usually, cosmetic applicators comprise a grip and a cosmetic application area. For example, the cosmetic application area may consist of a tuft of hair or a sponge. This application area is loaded with product to be applied on the skin of a user, then brought back onto the skin in order to transfer the product onto the skin. Finally, this application area allows distributing the product over the skin.

A drawback of this type of applicators is their lack of accuracy both during loading of the product and during transfer onto the skin. Indeed, the tufts of hair as well as the sponges are hardly loaded with the product in a uniform manner, which results in a non-uniform deposition of the product over the skin. Furthermore, these application devices hold a portion of the product, which results in product wastage and limits the application effectiveness. This applicator type is also difficult to clean.

Alternatively, it is known to use an application area in the form of a plastic or metallic element. However, the plastic or metallic application areas hardly hold the product to be applied. Hence, loading is difficult.

Another drawback of this type of applicators concerns wiping, in particular wiping of the grip of the applicator when the applicator is removed from a cosmetic product reservoir. Thus, the cosmetic product reservoir may comprise a means configured to wipe the grip, generally called wiper and formed at the outlet of the reservoir. The wiper is intended to wipe the grip which is immersed in the product reservoir. The grip is wiped in order to keep the most possible clean aspect but primarily to avoid the cosmetic product held on the grip dripping during application. The problem of the wiper is that it also wipes the application area, which is then loaded with a small amount of product.

Moreover, the functionalities ensured by these types of applicators are limited.

### SUMMARY

The present disclosure provides a cosmetic product application device comprising an application head, the application head comprising a cosmetic product loading area comprising a cavity formed in the application head and opening outwards the application head through at least one orifice, the application head comprising asperities.

For example, the application head comprises a material whose thermal effusivity is higher than that of the target surface, the target surface being the skin of a user.

By a cavity, it should be understood at least one cavity, i.e. one or more cavity/cavities, for example one single cavity or a plurality of cavities.

By cavity formed in the application head, it should be understood a cavity formed inside the application head. For example, the cavity may be in the form of an indentation, a hollow, a hole in the application head which opens outwards the application head through at least one orifice.

By at least one orifice, it should be understood that each cavity could open outwards the application head through one or more orifice(s), for example through one single orifice or through a plurality of orifices.

The cavity forms a housing in the application head configured to receive and hold the cosmetic product in the application head.

The cavity enables the application device and in particular the application head to be loaded with the cosmetic product to be applied over the target surface when the application device is immersed in a cosmetic product reservoir.

The transfer of the cosmetic product onto the target surface could be done either by capillarity, or by tapping on the skin.

The application head according to the present disclosure allows drawing a sufficient amount of the cosmetic product to be applied over the target surface when the application device is immersed in a cosmetic product reservoir. The product may be drawn and held in the cavity of the application head thereby offering an improved means for holding the cosmetic product.

Thus, the loading area allows drawing a cosmetic product and transferring it onto a target surface such as the skin of a user.

By asperities, it should be understood a portion of a surface, for example of a wall, for example a lateral wall of the application head which is rough or a projecting portion, such as a protrusion, for example a protuberance of a surface, for example of a wall, for example of a lateral wall of the application head.

The asperities allow adding new functionalities to the application device by further enabling an enhanced massage of the target surface or an exfoliation of the target surface.

According to other features of the present disclosure, the device includes one or more of the following optional features, considered separately or according to any possible combination.

According to one feature, the application head is manufactured by additive manufacturing also called 3D-printing.

The manufacturing process by 3D-printing confers a freedom of shapes and arrangements on the application head that is greater than that of conventional manufacturing processes (moulding, machining, etc.) and that being so, with no tooling or moulds that are expensive and whose manufacture is time-consuming. The application head may be designed freely according to the pursued gesture or even the used cosmetic product, and that being so, without any constraint thanks to the printing manufacturing process.

According to one feature, the application head comprises an area for applying the cosmetic product loaded on the loading area, over a target surface such as the skin of a user, the loading area and/or the application area comprising the asperities.

For example, the loading area and the application area are distinct from each other.

The application area allows distributing the product over the target surface, for example by uniform spreading.

According to one feature, the loading area comprises asperities, for example the loading area only comprises asperities.

According to one feature, the application area comprises asperities, for example the application area only comprises asperities.

According to one feature, the loading area and the application area comprise asperities.

According to one feature, the application head comprises a wall, for example a lateral wall and the asperities are formed in one-piece with the wall, for example the lateral wall of the application head.

The lateral wall of the application head comprises at least two lateral faces.

According to one feature, each asperity may be a portion projecting from a surface, for example from a wall, for example from a lateral wall of the application head.

According to one feature, the asperities consist of ribs, for example rectilinear, or protrusions, for examples lugs.

For example, the asperities may have a thickness comprised between 0.1 mm and 1 mm of thickness.

This configuration enables, inter alia, an enhanced massage of the target surface.

According to one feature, the asperities consist of rough surfaces, for example of the application head, for example of the wall of the application head.

Roughness is a characteristic of the condition of a surface.

For example, the application head has one or more rough surface(s).

Roughness may be measured in Ra which may be calculated in μm.

For example, the application head may have one or more rough surface(s) whose value may be comprised between 7 μm and 100 μm.

This configuration enables the application device to exfoliate the target surface.

According to one feature, the application head is hollow, the hollow of the application head forming the cavity of the loading area.

For example, the loading area comprises one single cavity formed by the hollow of the application head and opening outwards the application head through at least one orifice.

For example, the application head comprises an upper end, a lower end and a lateral wall connecting the ends, delimiting the hollow of the application head.

For example, said at least one orifice is formed in the lateral wall so as to create a passage between the outside of the application head and the cavity of the application head.

The hollow application head also allows reducing the weight of the application device and also providing a light application device.

According to one feature, the cavity opens outwards the application head through a plurality of orifices.

According to one feature, the orifices are arranged only over a first lateral face of the application head and the application area corresponds to a second lateral face of the application head. Thus, the loading area may, for example, correspond to the cavity and to the first lateral face of the application head on which said at least one orifice is arranged.

By first lateral face and second lateral face, it should be understood lateral faces of the lateral wall of the application head.

For example, the surface of the first lateral face, over which the orifices are arranged, is larger than the surface of the second lateral face.

By surface of the first lateral face, it should be understood the surface comprising the surface of the first lateral face including the orifices and/or the portion of the surface of the convex envelope, of the head or of the lateral wall, corresponding to the first lateral face.

For example, the first lateral face comprises the asperities. For example, the first lateral face only comprises the asperities. Thus, the loading area only comprises the.

For example, the second lateral face comprises the asperities. For example, the second lateral face only comprises the asperities. Thus, the application area only comprises the asperities.

For example, the first lateral face and the second lateral face comprise the asperities. Thus, the loading area and the application area comprise the asperities.

According to one feature, the orifices are arranged over a first lateral face and over a third lateral face of the application head, the first lateral face and the third lateral face being opposite to each other and the application area corresponds to a second lateral face and a fourth lateral face of the application head. The second lateral face and the fourth lateral face are disposed between the first lateral face and the third lateral face of the application head. Thus, the loading area may for example correspond to the cavity and to the first and third lateral faces of the application head on which the orifices are disposed.

By first lateral face, second lateral face, third lateral face and fourth lateral face, it should be understood lateral faces of the lateral wall of the application head.

For example, the first lateral face and/or the third face comprise the asperities. For example, the first lateral face and/or the third face only comprises the asperities. Thus, the loading area only comprises the asperities.

For example, the second lateral face and/or the fourth lateral face comprise the asperities. For example, the second lateral face and/or the fourth lateral face only comprise the asperities. Thus, the application area only comprises the asperities.

For example, the first lateral face and the second lateral face and the third lateral face and the fourth lateral face comprise the asperities. Thus, the loading area and the application area comprise the asperities.

According to one feature, the loading area extends only between the upper end and the lower end of the application head.

For example, the upper end and/or the lower end is/are devoid of any orifice.

According to one feature, the loading area and the application area are distinct from each other.

According to one feature, the application head comprises a material whose thermal effusivity is higher than that of the target surface and/or larger than that of the grip, the target surface being the skin of a user.

The thermal Effusivity is the capacity of a material to absorb calories and allows creating a cool sensation upon application.

The higher its value, the more the material will be able to absorb calories without heating up, and vice versa.

The thermal Effusivity intrinsic value of a material is calculated as follows:

$$Ef = \sqrt{k \cdot ρ \cdot c}$$

where k is the thermal capacity in W·m−1·° K.−1; P is the volumetric mass in kg/m3; c is the thermal conductivity in J·kg−1·° K.−1.

Thus, upon contact with the skin, while the parts are all at the same temperature, a part made of steel (whose Effusivity is in the range of 14,000 J·K−1·m−2·s−1/2) will impart a cool sensation on the skin (Effusivity of 400 J·K−1·m−2·s−1/2), while a part made of wood (Effusivity also in the range of 400 J·K−1·m−2·s−1/2) will impart a neutral sensation.

This heat transfer imparts on the skin a cool sensation that is even more acute as the thermal Effusivity is high.

According to one feature, the application head comprises a material whose thermal effusivity is higher than or equal to 7,000 J·K−1·m−2·s−1/2, for example higher than or equal to 10,000 J·K−1·m−2·s−1/2 and/or is lower than or equal to 18,000 J·K−1·m−2·s−1/2, for example lower than or equal to 16,000 J·K−1·m−2·s−1/2, for example lower than or equal to 14,000 J·K−1·m−2·s−1/2.

Thus, the application head is configured to confer a cool sensation on the target surface.

For example, the application area and/or the loading area comprises, for example consists of a material whose thermal effusivity is higher than that of the target surface and/or higher than that of the grip, the target surface being the skin of a user.

For example, the asperities comprise, for example consist of, a material whose thermal effusivity is higher than that of the target surface and/or higher than that of the grip, the target surface being the skin of a user.

For example, the application head is made of a material whose thermal effusivity is higher than that of the target surface and/or higher than that of the grip, the target surface being the skin of a user.

According to one feature, the application head comprises a metallic material. For example, the application head is made of metal. Thus, the application head and in particular the application area allows decongesting the target surface.

For example, the application head is made of a zinc or aluminium alloy which may be covered with an anticorrosive material.

The metal is a material that is relatively neutral with regards to the cosmetic products and the skin.

According to one feature, the application head is made of steel, for example of stainless steel.

According to one feature, the application device includes a grip connected to the application head, the grip consisting of one or several part(s).

According to one feature, the grip is a stick, for example a flexible stick.

According to one feature, the application device comprises an insert arranged on the application head, the insert comprising a material different from the material of the application head.

For example, the application head comprises a first material and the insert comprises a second material different from the first material. The first material being a material whose thermal effusivity is higher than that of the target surface, the target surface being the skin of a user.

For example, the first material with a thermal effusivity higher than that of the material(s) forming the insert may be brought into contact with the target surface.

For example, the second material, i.e. the material of the insert comprises fibers or a sponge.

For example, the insert is made of a plastic flocked with fibers.

For example, the insert is made of sponge.

For example, the insert is made of silk.

For example, the insert is made of felt.

For example, the application head and the insert are connected by clipping, gluing, clamping, welding or even overmoulding.

Thus, according to the present disclosure, the application device comprises the insert intended to enable the application device to apply the cosmetic product with more accuracy and the asperities allowing carrying out a massage and/or scrubbing of the target surface.

The present disclosure also relates to a set comprising the application device as described before and a cosmetic product reservoir.

The present disclosure also relates to a method for using a cosmetic product application device as described before, comprising the following steps: loading the cosmetic product on the loading area, transferring the cosmetic product on the target surface, distributing the cosmetic product by spreading thanks to the application area.

According to one feature, the step of transferring the cosmetic product is a dot-by-dot transfer step.

By “dot-by-dot transfer”, it should be understood that the product is transferred onto the target surface by tapping the application head on the target surface.

The present disclosure also relates to a method for manufacturing a cosmetic product application device as described before, the method comprising a step of manufacturing the application head by additive manufacturing wherein a cavity is formed in the application head and opens outwards the application head through at least one orifice and wherein asperities are formed on the application head.

### DRAWINGS

Other features and advantages of the present disclosure will appear upon reading the following description and upon examining the appended figures wherein:

FIG. 1 is a schematic view of a first side of a cosmetic product application device according to a first form of the present disclosure;

FIG. 2 is a schematic view of a second side of the device of FIG. 1;

FIG. 3 is a schematic view of a third side of the device of FIG. 1;

FIG. 4 is a schematic longitudinal sectional view of the application device according to the present disclosure;

FIG. 5 is a schematic view of a variant of the first form;

FIG. 6 is a schematic view of a variant of the first form of the present disclosure;

FIG. 7 is a schematic view of a variant of the first form of the present disclosure;

FIG. 8 is a schematic view of a variant of the first form of the present disclosure;

FIG. 9 is a schematic view of a first side of an applicator according to a second form of the present disclosure;

FIG. 10 is a schematic view of a second side of the applicator according to the second form;

FIG. 11 is a schematic view of an applicator according to a third form of the present disclosure;

FIG. 12 is a schematic view of a set comprising the application device and a cosmetic product reservoir;

FIG. 13 is a schematic longitudinal sectional view of an application device according to the present disclosure; and

FIG. 14 is a schematic side view of an application device according to one variant of the present disclosure.

### DETAILED DESCRIPTION

In the following description and in the claims, identical, similar or analogous components will be designated by the same reference numerals.

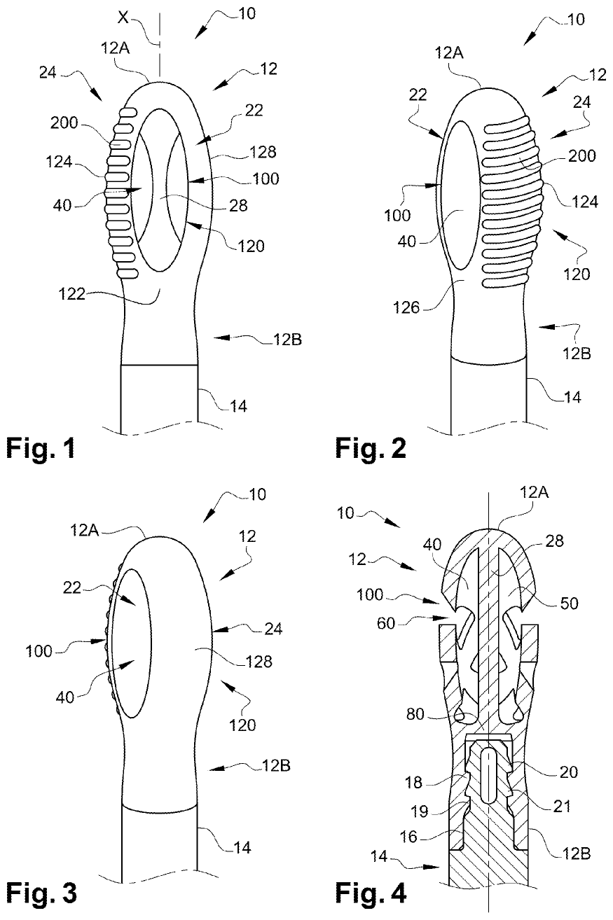

FIGS. 1 to 11 represent a cosmetic product application device 10 comprising an application head 12 configured to apply a cosmetic product over a target surface such as the skin of a user.

The application head 12 may comprise an upper end 12A, a lower end 12B and a lateral wall 120 connecting the upper end 12A and the lower end 12B.

In the present disclosure, the upper end 12A, the lower end 12B and the lateral wall 120 are formed in one-piece, i.e. as a single part.

FIGS. 1 to 8 show that the cosmetic product application device 10 may include a grip 14.

As illustrated in FIG. 4, the grip 14 may be connected to the application head 12, for example by clipping.

To this end, the lower end 12B of the application head 12 may have an elongate shape and may be hollow, and the grip 14 may include a protrusion 16 at one of its ends, proximal to the application head 12.

The protrusion 16 is configured to fit by clipping into, i.e. inside the lower end 12B of the application head.

More particularly, the application head 12 may comprise at least one inner shoulder 18 configured to cooperate with an outer shoulder 20 of the protrusion 16.

The application head 12 may comprise a second inner shoulder 19 configured to cooperate with a second outer shoulder 21 of the protrusion 16.

The present disclosure is not limited to this form. For example, the grip 14 could have the hollow end, and the lower end 12B could be configured to be accommodated in the hollow end of the grip and include the protrusion at one of its ends.

According to another variant, the grip 14 may be connected to the application head 12, for example by screwing.

In the represented example, the grip 14 is made in one-piece. Alternatively, the grip 14 could include several parts.

For example, the grip 14 may be a stick, for example a flexible stick.

The upper end 12A corresponds to the end distal to the grip 14 when the application head 12 is connected to the grip 14 and the lower end 12B corresponds to the end proximal to the grip 14 when the application head 12 is connected to the grip 14.

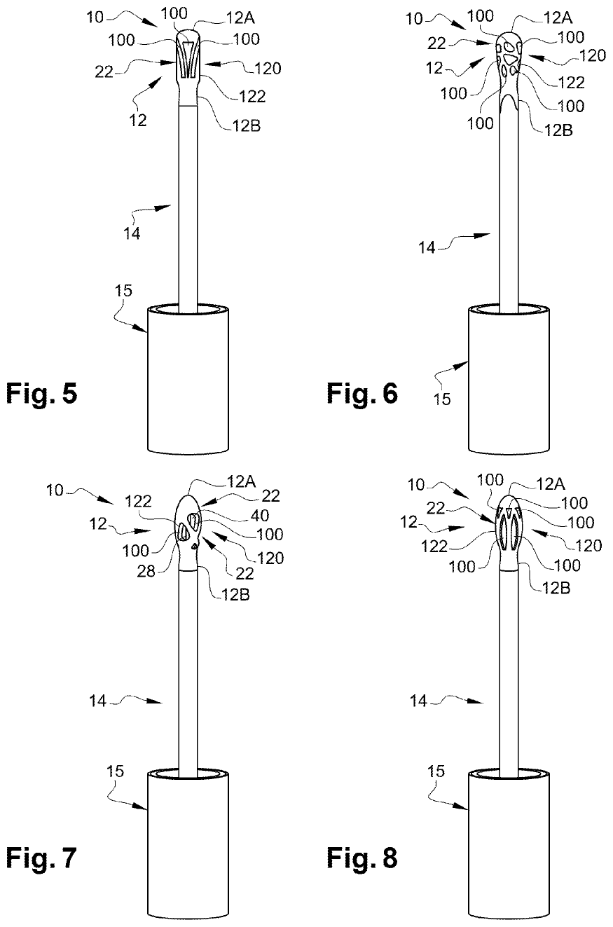

The application device 10 may comprise a sealing element 15 (FIGS. 5 to 8) configured to seal an outlet orifice of a reservoir (not represented) when the application device 10 is mounted on the reservoir. The reservoir may be a cosmetic product reservoir.

The sealing element 15 may be a cap or cowl fastened to the grip 14, for example by screwing, for example at the level of one of the ends of the grip 14, distal to the application head 12.

The cap 15 is configured to be mounted on the reservoir so as to seal the outlet orifice of the reservoir when the rest of the application device i.e. the grip 14 and the application head 12 extends inside the reservoir.

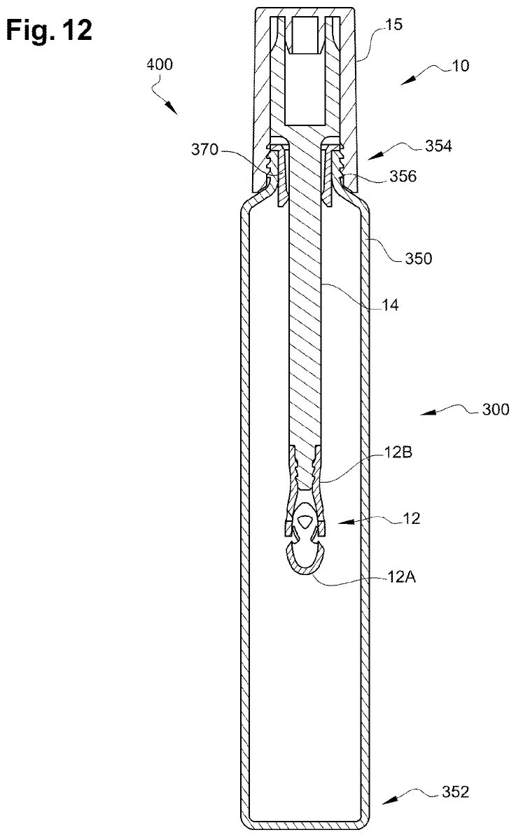

A set 400 comprising the application device 10 and a cosmetic product reservoir 300 is illustrated in FIG. 12.

The application device 10 comprises the application head 12, the grip 14 and the cap 15.

The reservoir 300 comprises a body 350 delimiting an inner chamber comprising a cosmetic product. The body 350 comprises a closed first end 352 and a second end 354, opposite to the first end. The second end has a collar 356 comprising a cosmetic product outlet orifice.

In FIG. 12, the application device 10 is mounted on the reservoir so that the application head 12 and the grip are immersed in the cosmetic product. The cap is screwed onto the collar 356 of the reservoir so as to seal the outlet orifice of the cosmetic product.

The reservoir 300 may comprise a wiper 370 mounted inside the collar 356 of the reservoir. The wiper is configured to wipe the grip 14 when the application device 10 is removed from the reservoir 300.

As illustrated in the figures, the application head 12 may comprise a cosmetic product loading area 22.

The loading area 22 allows drawing the cosmetic product and transferring it onto a target surface such as the skin of a user.

In the present disclosure, the loading area 22 comprises a cavity 40 formed in the application head 12.

The cavity 40 may open outwards the application head 12 through at least one orifice 100.

By a cavity, it should be understood at least one cavity, i.e. one or more cavity/cavities, for example one single cavity or a plurality of cavities.

By a cavity formed in the application head, it should be understood a cavity formed inside the application head. For example, the cavity may be in the form of an indentation, a hole or a hollow in the application head which opens outwards the application head through at least one orifice.

The cavity 40 forms a housing in the application head configured to receive and hold the cosmetic product in the application head 12.

By at least one orifice, it should be understood that each cavity could open outwards the cavity through one or more orifice(s), for example through a single orifice or through a plurality of orifices.

Said at least one orifice 100 enables a passage of the cosmetic product between the outside of the application head 12 and the cavity 40 of the application head 12.

For example, the cosmetic product may be drawn by immersing the application head 12 in the cosmetic product reservoir so that the cavity is loaded with cosmetic product. When the application head 12 is removed from the reservoir, the loaded cosmetic product is stored in the loading area until being unloaded/transferred on the target surface of the user. The configuration of the application device enables the cosmetic product to be held inside the application head 12 and not to be wiped by the wiper 370 when the application device 10 is removed from the reservoir.

The loading area 22 may be configured to transfer dot-by-dot the cosmetic product on the target surface.

In the present disclosure, the loading area 22 may open only and/or extend only between the upper end 12A and the lower end 12B of the application head.

For example, the orifice(s) is/are arranged only over the lateral wall 120 of the application head 12.

For example, the upper end 12A and/or the lower end 12B is/are devoid of any orifice through which the cavity opens, for example is/are devoid of any orifice.

As illustrated in FIGS. 1 to 10, the application head 12 may comprise an area 24, for example for applying the cosmetic product loaded on the loading area.

The application area 24 further allows distributing the product over the target surface, by uniform spreading.

The application area 24 may be formed by one of the lateral faces 124, 128 of the application head 12.

By one of the lateral faces 124, 128 of the application head 12, it should be understood one of the lateral faces 124, 128 of the lateral wall 120 of the application head.

The loading area 22 and the application area 24 may be configured to be separately brought into contact with the target surface.

For example, the loading area 22 and the application area 24 may be distinct (FIGS. 1 to 10).

The loading area 22 and the application area 24 may be configured to be simultaneously brought into contact with the target surface.

In the present disclosure, the application head 12 may be manufactured by additive manufacturing also called 3D-printing.

Thus, the application head 12 may be designed freely according to the desired gesture or even the used cosmetic product, and that being so, without any constraint, thanks to the 3D-printing manufacturing process.

Thus, the application head 12 may have various shapes.

For example, the lateral wall 120 may have a frustoconical, oval general shape, etc.

Without limitation, the upper end 12A may have a rounded shape.

Without limitation, the lower end 12B may have an elongate shape.

According to one form, the application head 12 may be hollow.

By hollow application head 12, it should be understood that the application head 12 is empty inside. It should be understood that the inside of the application head 12 is empty.

For example, the upper end 12A, the lower end 12B and the lateral wall 120 connecting the ends 12A, 12B delimit a hollow 50 in the application head 12 (FIG. 4).

The hollow application head 12 allows reducing the weight of the application device and also providing a light application device.

In this example, the loading area 22 may comprise a single cavity 40, the single cavity being formed by the hollow 50 of the application head 12 and opening outwards the application head 12 through at least one orifice 100.

Said at least one orifice 100 may be formed in the application head 12 so as to create a passage 60 between the outside of the application head and the cavity 40 of the application head (FIG. 4).

For example, said at least one orifice 100 may be formed/arranged in the lateral wall 120 of the application head.

For example, the cavity 50 may open outwards the application head 12 through a single orifice.

For example, the cavity 50 may open outwards the application head 12 through a plurality of orifices (FIGS. 1 to 11).

As illustrated in FIGS. 5 to 8, the orifices 100 may, for example, be arranged over the same lateral face 122 of the lateral wall 120.

For example, the orifices 100 may be arranged only over a first lateral face 122 of the lateral wall 120 and the application area 24 may correspond to a second lateral face 124 of the lateral wall 120 (not visible in FIGS. 5 to 8).

The surface of the first lateral face 122 over which the orifices 100 are arranged may be identical to the surface of the second lateral face 124, larger than the surface of the second lateral face 124 or smaller.

It should be understood that the surface of the first lateral face comprises the surface of the orifices.

As illustrated in FIGS. 1 to 3 and 9 and 10, the orifices 100 may be arranged over a first lateral face 122 and over a third lateral face 126, for example of the lateral wall 120, of the application head, the first lateral face 122 and the third lateral face 126 being opposite to each other.

In this example, the application area 24 may correspond to a second lateral face 124 and a fourth lateral face 128, for example of the lateral wall 120, of the application head. The second lateral face 124 and the fourth lateral face 128 are disposed respectively between the first lateral face 122 and the third lateral face 126 of the application head.

In the present disclosure, the orifice(s) may have various geometric shapes such as a triangular, rectangular, round, oval shape, etc.

In the case where the cavity 40 opens outwards the application head through a plurality of orifices 100, these orifices 100 may have an identical or different shape.

In the present disclosure, the loading area 22 and/or the application area 24 may comprise asperities 200.

By asperity, it should be understood a portion projecting from a surface, for example from the lateral wall 120, of the application head 12.

The asperities 200 allow adding new functionalities to the application device and further enable an enhanced massage of the target surface or enable exfoliating the target surface.

For example, the asperities 200 consist of projections extending from an outer surface of the lateral wall 120.

For example, the asperities 200 are made in one-piece, i.e. integral with the lateral wall 120 of the application head 12.

The asperities may extend only between the upper end 12A and the lower end 12B of the application head.

For example, the asperities are arranged over the lateral wall 120 of the application head 12 only.

For example, the upper end 12A and/or the lower end 12B is/are devoid of asperities.

The asperities 200 may have different shapes such as ribs 205 (FIGS. 1 to 3 and 5 to 6), for example rectilinear, or lugs 210 (FIG. 11).

In the present disclosure, the asperities 200 may be formed in one-piece with the application head 12, for example with the wall 120 of the application head 12 and in the same material.

The application area 24 may comprise the asperities as illustrated in FIGS. 1 to 3 and 5 to 8.

The asperities 200 may be disposed over all or part of the application area 24. For example, the asperities may be disposed over one of the faces or the faces, for examples all faces of the lateral wall 120 forming the application area 24.

For example, the application area 24 only may comprise the asperities 200.

A first example is illustrated in FIGS. 1 to 3.

In this example, the application head 12 comprises the upper end 12A, the lower end 12B and the lateral wall 120 connecting the two ends 12A, 12B. For example, the lateral wall 120 may have a cambered shape, for example so as to define, in combination with the upper end 12A an oval shape. The lateral wall 120, for example with the cambered shape, may have a central portion, the central portion may have a diameter larger than the rest of the application head 12. In this form, the cavity 40, for example the single cavity 40, opens outwards the application head through two orifices 100. Each orifice has a shape, for example an elongate shape according to a direction connecting the lower end 12B and the upper end 12A, for example an oval shape. The two orifices 100 are arranged respectively over a first lateral face 122 (FIG. 1) and over a third lateral face 126 (FIG. 2) of the lateral wall 120 of the application head. For example, the first lateral wall 122 has one of the two orifices 100 and the third lateral wall 126 has the second orifice 100. In the represented example, the first lateral face 122 and the third lateral face 126 are opposite to each other. These orifices 100 allow forming a passage between the outside of the application head 12 and the cavity 40 and are connected to each other. In this example, the application area 24 may correspond to a second lateral face 124 and to a fourth lateral face 128 (FIG. 1), for example of the lateral wall 120, of the application head. The second lateral face 124 and the fourth lateral face 128 are disposed respectively between the first lateral face 122 and the third lateral face 126 of the application head. In this example, the asperities 200 may extend over only one portion of the application area 24. For example, the second lateral face 124 may have the asperities 200 and the fourth lateral face 128 may have a smooth outer surface. This configuration enables a user to select between a portion of the application area, with no asperities, for example smooth, so as to apply the cosmetic product over the target surface and another portion of the application area 24 comprising the asperities 200 so as to massage and/or exfoliate the target surface.

As illustrated in FIGS. 1 and 4, the application device 10 may comprise a reinforcing element 28, for example an arm extending in the hollow 50 of the application head 12 forming the cavity 40. For example, the reinforcing element 28 extends from the upper end 12A down to the lower end 12B.

Other examples wherein the application area 24, for example only, comprises the asperities 200 are illustrated in FIGS. 5 to 8.

In these examples, the lateral wall 120 of the application head may comprise two lateral faces only, for example a first lateral face 122 and a second lateral face 124. For example, the cavity 40 may open through the plurality of orifices arranged over the first lateral face 122 only and the application area 24 may comprise at the second lateral face 124 (not visible in the figures). For example, the second lateral face 124 is opposite to the first lateral face 122.

In the example illustrated in FIG. 5, the application head 12 comprises the upper end 12A, the lower end 12B and the lateral wall 120 connecting the two ends 12A, 12B. The lateral wall 120 may have a cylindrical general shape. In this form, the cavity 40, for example the single cavity 40 (not visible) opens outwards the application head through a plurality of orifices 100. The plurality of orifices is arranged only over a first lateral face 122 of the lateral wall 120 of the application head. The first lateral face 122 has a first central orifice 100 with a shape flaring in the direction of the lower end 12B, for example triangular. The first central orifice 100 may be arranged between several other orifices, for example four other orifices 100, for example rectangular shaped. Two of the other orifices 100 (two of the four orifices are visible in FIG. 5), for example rectangular, may be arranged on each side of the rectangular orifice 100. The orifices 100 allow forming a passage between the outside of the application head 12 and the cavity 40. In turn, the application area 24 corresponds to the second lateral face 124 of the application head comprising the asperities (not visible). In this variant, the surface of the first lateral face 122 which has the orifices 100 may be larger than the surface of the second lateral face 124 forming the application area 24 and comprising the asperities 200.

In the example illustrated in FIG. 6, the application head 12 comprises the upper end 12A, the lower end 12B and the lateral wall 120 connecting the two ends 12A, 12B. For example, the lateral wall 120 may have a frustoconical shape for example with a section decreasing from the upper end 12A down to the lower end 12B. In this form, the cavity 40, for example the single cavity 40, opens outwards the application head through a plurality of orifices 100. The plurality of orifices is arranged only over a first lateral face 122 of the lateral wall 120 of the application head. The first lateral face 122 has orifices, for example eight orifices, with rounded shapes. These orifices 100 allow forming a passage between the outside of the application head 12 and the cavity 40. In turn, the application area 24 corresponds to a second lateral face 124 of the lateral wall 120 comprising the asperities 200 (not visible). In this variant, the surface of the first lateral face 122 which has the orifices 100 may be identical to the surface of the second lateral face 124 forming the application area 24 and comprising the asperities 200.

As illustrated in FIG. 7, the application head 12 comprises the upper end 12A, the lower end 12B and the lateral wall 120 connecting the two ends 12A, 12B. For example, the lateral wall 120 may have an oval shape. In this form, the cavity 40, for example the single cavity 40 opens outwards the application head through a plurality of orifices 100. The plurality of orifices is arranged over a first lateral face 122 of the lateral wall 120 of the application head. The first lateral face 122 has a plurality of orifices 100 with a triangular shape one of the edges of which is rounded. These orifices 100 allow forming a passage between the outside of the application head 12 and the cavity 40. In turn, the application area 24 corresponds to a second lateral face 124 of the lateral wall comprising the asperities 200 (not visible). In this variant, the surface of the first lateral face 122 which has the orifices 100 may be larger than the surface of the second lateral face 124 forming the application area 24 and comprising the asperities 200.

As illustrated in FIG. 8, the application head 12 comprises the upper end 12A, the lower end 12B and the lateral wall 120 connecting the two ends 12A, 12B. For example, the lateral wall 120 may have an oval shape, whose central portion may have a diameter larger than the rest of the application head 12. In this form, the cavity 40, for example the single cavity 40 opens outwards the application head through a plurality of orifices 100. The plurality of orifices is arranged only over a first lateral face 122 of the lateral wall 120 of the application head. The first lateral face 122 has the plurality of orifices 100 having an elongate shape, for example an oval or lozenge shape, distributed parallel to each other and a plurality of orifices with a flared shape, for example flaring in the direction and way defined from the lower end 12B towards the upper end 12A, for example triangular, each disposed above and between each of the oval or lozenge shaped orifices. For example, the triangular shaped orifices are proximal to the upper end 12A of the application head 12. These orifices 100 allow forming a passage between the outside of the application head 12 and the cavity 40. In turn, the application area 24 corresponds to a second lateral face 124 of the lateral wall 120 comprising the asperities 200 (not visible). In this variant, the surface of the first lateral face 122 which has the orifices 100 may be larger than the surface of the second lateral face 124 forming the application area 24 and comprising the asperities.

The loading area 22 may comprise the asperities 200.

The asperities 200 may be disposed over one of the faces or over the faces, for example all of the faces of the lateral wall 120 over which the orifices 100 are arranged.

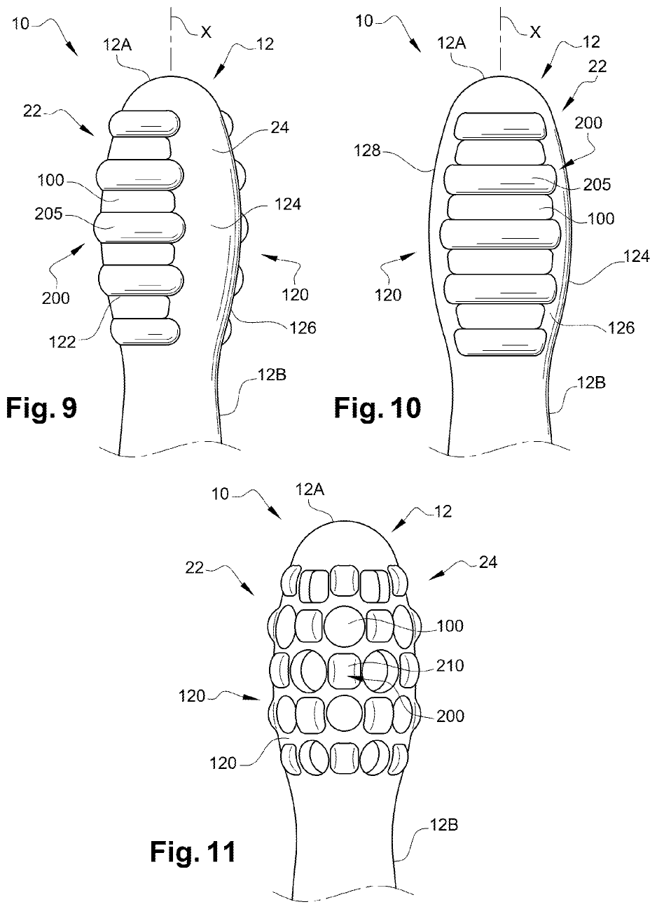

An example is illustrated in FIGS. 9 and 10.

In this example, the application head 12 comprises the upper end 12A, the lower end 12B and the lateral wall 120 connecting the two ends 12A, 12B. For example, the lateral wall 120 may have a cambered shape, for example so as to define in combination with the upper end 12A an oval shape. The lateral wall 120, for example with the cambered shape, may have a central portion, the central portion may have a diameter larger than the rest of the application head 12.

In this example, the cavity 40, for example the single cavity 40, opens outwards the application head through two groups of orifices 100. The two groups of orifices 100 are respectively arranged over a first lateral face 122 and over a third lateral face 126 (FIG. 9) of the lateral wall 120 of the application head. For example, the first lateral wall 122 has one of the two groups of orifices 100 and the third lateral wall 126 has the second group of orifices 100.

In the represented example, the first lateral face 122 and the third lateral face 126 are opposite to each other. Each group of orifices has several orifices with a shape, for example elongate, for example rectangular, for example with rounded vertices, and arranged below one another according to a direction connecting the lower end 12B and the upper end 12A.

For example, each group of orifices comprises a plurality of orifices, for example at least four orifices, for example exactly four orifices, arranged below one another according to the direction connecting the lower end 12B and the upper end 12A. These orifices 100 allow forming a passage between the outside of the application head 12 and the cavity 40 and are connected to each other, for example via the cavity.

In this example, the first lateral face 122 and the third lateral face 126 comprise the asperities 200. For example, the first lateral face 122 and the third lateral face 126 only may comprise the asperities 200. For example, the asperities 200 may be arranged over the portions of the lateral wall 120 arranged between the orifices 100. For example, the orifices 100 and the asperities 200 may be arranged on either side of each of the orifices, according to the direction connecting the lower end 12B and the upper end 12A.

In this example, the asperities 200 may consist of ribs 205, for example rectilinear having for example a cambered outer surface and having for example rounded ends. For example, the ribs 205 may project from the lateral wall 120. The ribs 205 may be made in one-piece with the application head 12, for example with the lateral wall 120. In this example, the application area 24 may correspond to a second lateral face 124 and to a fourth lateral face 128 (FIG. 10), for example from the lateral wall 120, of the application head. The second lateral face 124 and the fourth lateral face 128 are disposed respectively between the first lateral face 122 and the third lateral face 126 of the application head. In this example, the second lateral face 124 and the fourth lateral face 128 which form the application area 24 may have a smooth outer surface.

In the previously-described examples, the loading area 22 and the application area 4 may be distinct from each other. Thus, the loading area 22 and the application area 24 may be configured to be separately brought into contact with the target surface.

The loading area 22 and the application area 24 may comprise asperities 200.

For example, the application head 12 may be similar to the example of the application head 12 illustrated in FIGS. 9 and 10, unlike the second lateral face 124 and the fourth lateral face 128 which form the application area 24 having no smooth outer surface but asperities 200.

According to this example wherein the loading area 22 and the application area 24 may comprise asperities 200, the loading area 22 and the application area 24 may be distinct from each other.

The form illustrated in FIG. 11 is similar to the above-described forms and may comprise all of their features except that the application device does not comprise an application area 24.

In the application device illustrated in FIG. 11, the orifices may extend over the entirety of the wall, for example over the entirety of the circumference of the application head 12.

For example, the asperities may extend over the loading area, for example, the loading area only.

In the example illustrated in FIG. 11, the application head 12 comprises the upper end 12A, the lower end 12B and the lateral wall 120 connecting the two ends 12A, 12B. For example, the lateral wall 120 may have a cambered shape, for example so as to define in combination with the upper end 12A an oval shape. The lateral wall 120, for example with the cambered shape, may have a central portion, the central portion may have a diameter larger than the rest of the application head 12. In this form, the cavity 40, for example the single cavity 40, opens outwards the application head through the plurality of orifices 100. The plurality of orifices may be formed over the entirety of the surface of the lateral wall 120, over all of the faces of the lateral wall 120. In this example, the orifices may have different shapes. For example, the orifices proximal to the upper end 12A may have a square shape and the other orifices may have a rounded shape. These orifices 100 allow forming a passage between the outside of the application head 12 and the cavity 40 and are connected to each other. In this example, the asperities may be arranged over the portions of the lateral wall 120 arranged between the orifices 100. In this example, the asperities 200 may consist of lugs 210. For example, the lugs 210 may project from the lateral wall 120. The lugs 210 may be made in one-piece with the application head 12, for example with the lateral wall 120. The lugs may be cambered, for example with a cambered surface, for example shaped as a laid cylinder section, for example having a cylinder axis orthogonal to a longitudinal axis X of the application head 12.

According to another form which is not illustrated, the application head 12 may be essentially solid, for example substantially solid, and the loading area may comprise a cavity opening outwards the application head 12 through a single orifice. In this form, the cavity may form an indentation or a hole, for example a blind hole inside the application head 12. The application area may comprise one or more cavity/cavities opening outwards the application head 12 through a single orifice.

The application head 12 may comprise or be made of a material whose thermal effusivity is higher than that of the target surface, the target surface being the skin of a user and/or larger than that of the grip 14.

This enables the application head 12 to confer a cool sensation and therefore a decongesting effect on the target surface.

For example, the application head 12 comprises a metallic material. For example, the application head 12 is made of metal, for example in its entirety.

For example, the application head 12 is made of a zinc or aluminium alloy which may be covered with an anticorrosive material.

For example, the application head 12 is made of steel, for example made of stainless steel, such as 316L steel.

For example, the application head 12 comprises a ceramic material. For example, the application head 12 is made of ceramic, for example in its entirety.

For example, the material may comprise or be an aluminium oxide-based ceramic.

Metal and ceramic are materials whose thermal effusivity allow conferring a cool sensation when they are applied over a target surface such as the skin of a user.

FIG. 14 illustrates a variant wherein the application device 10 may comprise an insert 90.

The insert 90 is configured to enable the application device 10 to apply the cosmetic product with more accuracy.

The insert 90 may be arranged on the application head 12. The application head 12 and the insert may be connected, without limitation, for example by clipping, gluing, clamping, welding or overmoulding.

For example, the application head 12 may comprise a first material and the insert 90 may comprise a second material different from the first material. The first material being a material whose thermal effusivity is higher than that of the target surface, the target surface being the skin of a user.

The second material, i.e. the material of the insert may comprise fibers, for example, or a sponge.

For example, the insert is made of a plastic flocked with fibers.

In other variants, the insert 90 may be made of sponge, of silk, or of felt.

In the example illustrated in FIG. 14, the application device 10 comprises the application head 12 and the insert 90. In this example, the insert 90 is formed on the upper end 12A, for example planar, of the application head 12. The insert 90 may have a cambered shape.

The present disclosure is not limited to the examples that have just been described. For example, for each example, the loading area and/or the application area may comprise asperities.

A method for using a cosmetic product application device 10 as described before, is described later on.

The use method comprises a first step 1 of loading the cosmetic product on the loading area 22, a second step 2 of transferring dot-by-dot the cosmetic product onto a target surface, and a third step 3 of distributing the cosmetic product by spreading thanks to the application area 24.

A method for manufacturing the application device is described later on.

The method comprises a step of manufacturing the application head 12 by additive manufacturing, also called 3D-printing, wherein a cavity 40 is formed in the application head 12 and opens outwards the application head 12 through at least one orifice 100 and in which asperities 200, for example all of the asperities or some of the asperities, are formed on the application head 12.

The method may comprise a step in which the asperities 200 are formed in the loading area 22 and/or in the application area 24.

The method may comprise a step in which the asperities 200 are formed over the lateral wall 120 of the application head.

For example, the asperities are made in one-piece with the lateral wall 120 of the application head 12.

The additive manufacturing process used to manufacture the application head 12 may consists in the injection of a binder on a powder bed also known as “Binder Jetting”.

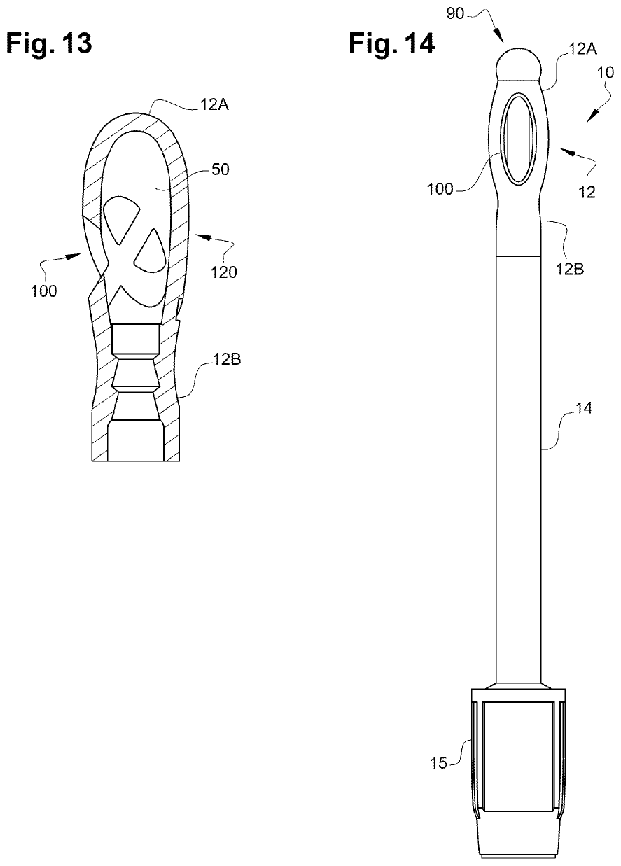

FIG. 13 illustrates a variant wherein the hollow formed inside the application head 12 and the hollow of the elongate portion of the lower end 12B of the application head 12 communicate with each other and are no longer separated by a flat surface 80 (FIG. 4). This configuration allows eliminating the remaining powder that might remain in the elongate portion of the lower end 12B of the application head 12 at the end of the step of manufacturing the application head 12 by 3D-printing. In this form, the application device 10 may be devoid of any reinforcing element 28.

1. A cosmetic product application device, comprising an application head, the application head comprising:
a cosmetic product loading area comprising a cavity formed in the application head and opening outwards the application head through at least one orifice,
the application head comprising a material whose thermal effusivity is higher than that of a target surface, the target surface being skin of a user, and the application head comprising asperities.

2. The application device according to claim 1, wherein the application head is hollow, the hollow of the application head forming the cavity of the cosmetic product loading area.

3. The application device according to claim 2, wherein the cavity opens outwards the application head through a plurality of orifices.

4. The application device according to claim 3, wherein the application head comprises:
an area for applying cosmetic product loaded on the cosmetic product loading area, over the target surface,
wherein at least one of the cosmetic product loading area and the area for applying cosmetic product comprises the asperities.

5. The application device according to claim 4, wherein the plurality of orifices are arranged only over a first lateral face of the application head and wherein the area for applying cosmetic product corresponds corresponds to a second lateral face of the application head.

6. The application device according to claim 5, wherein at least one of the first lateral face and the second lateral face comprises the asperities.

7. The application device according to claim 4, wherein plurality of the orifices are arranged over a first lateral face and over a third lateral face of the application head, the first lateral face and the third lateral face being opposite to each other and wherein the area for applying cosmetic product corresponds to a second lateral face and a fourth lateral face of the application head disposed respectively between the first lateral face and the third lateral face of the application head.

8. The application device according to claim 7, wherein at least one of the first lateral face, the second lateral face, the third lateral face, and the fourth lateral face comprises the asperities.

9. The application device according to claim 1, wherein the loading area comprises the asperities.

10. The application device according to claim 1, wherein the application head comprises a lateral wall and wherein the asperities are made in one-piece with the lateral wall.

11. The application device according to claim 1, wherein the asperities comprise ribs.

12. The application device according to claim 1, wherein the asperities comprise lugs.

13. The application device according to claim 1, wherein the application head comprises an upper end, a lower end and a lateral wall connecting the upper end and the lower end and wherein the asperities extend only between the upper end and the lower end of the application head.

14. The application device according to claim 13, wherein at least one of the upper end and the lower end is devoid of asperities.

15. The application device according to claim 1, wherein the application head comprises a metallic material.

16. The application device according to claim 1, further comprising an insert arranged on the application head, the insert comprising a material different from the material of the application head.

17. A set comprising the application device according to claim 1 and a cosmetic product reservoir.

18. A method for manufacturing the application device according to claim 1, the method comprising a step of manufacturing the application head by additive manufacturing wherein a cavity is formed in the application head and opens outwards the application head through at least one orifice and wherein asperities are formed over the application head.
